(19) United States
(12) Patent Application Publication
(10) Pub. No.: US 2020/0291848 A1
(43) Pub. Date: Sep. 17, 2020

(54) Power and miles per gallon for an automotive engine by using 2 stroke technology where the lubrication of the engine parts is independent of the fuel system.

(71) Applicant: Barnett Joel Robinson, Brookline, MA (US)

(72) Inventor: Barnett Joel Robinson, Brookline, MA (US)

(21) Appl. No.: 16/352,930

(22) Filed: Mar. 14, 2019

(51) Int. Cl. F02B 37/04; F02B 39/10; F02B 75/02; F01L 1/02; F01M 3/00

(52) U.S. Cl. CPC F02B 37/04; F02B 39/10; F02B 75/02; F02B 2720/237; F01M 3/00; F02B 2075/025; F01L 1/022

(57) ABSTRACT

The present invention provides a system and method for providing a wheel fuel efficiency improvement of at least 30% in a gasoline internal combustion engine, the system including a two-stroke engine, a crank case and oil pump in fluid communication with said two-stroke engine but independent of the fuel system of the engine and at least one of a turbocharger and/or another means of providing compressed air in fluid communication with a combustion chamber in said two-stroke engine, wherein camshafts are required to rotate at the same number of revolutions per minute as the crankshaft and that the gasoline can be injected directly into the combustion chamber and will not enter the combustion chamber via an intake manifold.

### BACKGROUND OF THE INVENTION

Most land and sea vehicles use gasoline or diesel fuel as a fuel for running their engines. Many engine designs are fuel inefficient.

In the field of internal combustion engine engineering the benefits of the 2 stroke engine over the 4 stroke engine are well known. The operation of the 2 stroke turbo charged diesel engine where the lubrication of the engine's moving parts is independent of the fuel is a well-known technology. The lubrication process is performed just as it is performed in 4 stroke engines with a crankcase, oil pump and lubricating oil, independent of the fuel.

U.S Pat. No. 7,040,264—by the present author—teaches us that the optimum power event terminates half-way down the power stroke of either a 4 stroke or a 2 stroke engine. The primary exhaust event takes place as soon as the exhaust valve is open which should be half-way down the power stroke, but there does remain burnt gases that still do need to be expelled.

There still remains an unmet need for improved efficiency in gasoline vehicle engines and methods.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention provides a system and method for applying the concepts of a 2 stroke diesel engine to the use of gasoline and therefore benefitting from the application of catalytic converters and a smaller combustion chamber.

The present invention includes a two-stroke engine, a crank case and oil pump in fluid communication with said two-stroke engine and at least one of a turbocharger and/or another method of supplying compressed air with a combustion chamber in said two-stroke engine.

The present invention combines the advantage of a two stroke diesel engine with lubrication that is independent of the fuel and the advantages of modifying the concepts of such a 2 stroke engine to burn gasoline instead of diesel fuel.

The present invention provides a system and method for providing a wheel fuel efficiency of at least 30% in a vehicle, the system including a two-stroke engine, a crank case and oil pump in fluid communication with said two-stroke engine and at least one of a turbocharger and/or another method of supplying compressed air with a combustion chamber in said two-stroke engine.

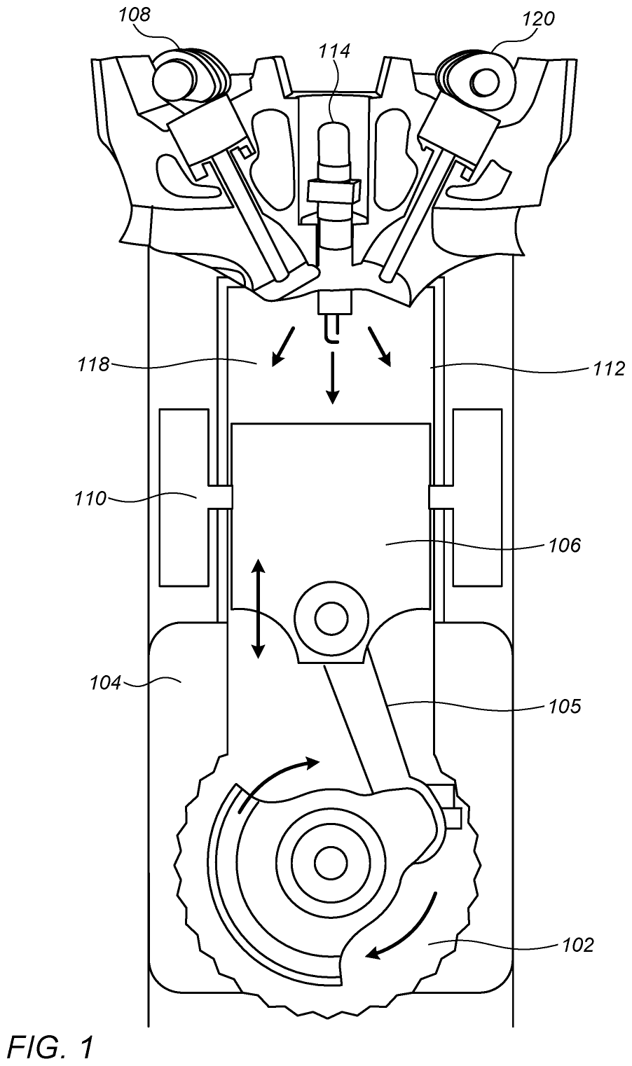

Reference is now made to FIG. 1, which is a simplified schematic illustration of a 2 stroke engine system 100, in accordance with an embodiment of the present invention.

The two-stroke engine system 100 of the present invention comprises a crankshaft 102 in a crankcase 104. The crankshaft 102 is connected via a connecting rod 105 to a piston 106. The piston is in fluid connection with a gasoline injection point 112 in the combustion chamber 118, which in turn, is connected to a spark plug 114 and the combustion chamber has an exhaust valve 108, typically disposed at the top of the chamber.

The two stroke engine system 100 may further comprise an intake valve 120 (if intake port 110 is not used). Alternatively, there may be an intake port 110 if the intake valve is not present.

If ports 110 are to be used, they will be used as intake ports, then 108 and 120 are exhaust valves.

Alternatively, if there are not to be ports 110, then 108 will be the intake valve and 120 will be the exhaust valve. Or 120 can be the intake valve and 108 can be the exhaust valve.

According to some embodiments of the present invention, the two-stroke engine system 100 of FIG. 1 provides a wheel fuel efficiency of at least 30%, for a vehicle, such as a car, when the fuel is gasoline.

The present invention combines the advantage of a two-stroke diesel engine with lubrication that is independent of the fuel and the advantages of modifying the concepts of such a two-stroke engine to burn gasoline instead of diesel fuel.

The objective in designing an internal combustion engine has always been to get the maximum amount of power with the smallest displacement engine and that will be the most fuel efficient.

The inventor of this invention previously taught an important concept in one of his prior patents that will help us understand the present teaching. U.S. Pat. No. 7,040,264 teaches that the optimum power event really ends half-way down the power stroke and that the optimum exhaust event occurs immediately following the opening of the exhaust valve as soon as the piston reaches halfway down the power stroke.

In addition, since the basic law of gasses PV=NRT (Pressure×Volume=Quantity of Fuel×Temperature) teaches us that since the compression event starts further up the up stroke on a 2 stroke engine than on a 4 stroke engine, the combustion chamber size at top dead center can be reduced significantly.

Therefore the smaller the combustion chamber at top dead center the higher the temperature when burning the same amount of fuel. The higher the temperature, the greater is the pressure on the piston. And the pressure on the piston is directly proportional to the power to the wheels.

It has previously been explained how each of the three of the four events, the compression event, the power event and the exhaust event need only half of a stroke. If intake ports are to be used instead of intake valves the duration of the intake activity will also be in the 90 degree duration range. The inventor now teaches how to perform an intake event without induction and how all four events are controlled in the 2-stroke engine of the present invention.

Therefore, the two strokes will be the upward intake-compression stroke and the downward power-exhaust stroke.

If we ignore the preconceived concept that “intake” is synonymous with “induction” and think about pushing compressed air into the intake manifold with a turbocharger or some other method of compressing air, we can get the combustion air into the combustion chamber during the first quarter to the first half (that is the bottom half) of the upward (i.e. the intake-compression) stroke.

It is also possible to utilize two intake ports or two intake valves or one intake port with one intake valve where one would be used to expel the remaining exhaust gasses and the second to supply the air for combustion purposes.

Direct fuel injection into the combustion chamber is required, because we will begin to push air into the combustion chamber during the latter part of the exhaust event to guarantee a more complete removal of the exhaust gases. the fuel will be injected directly into each combustion chamber and not into an intake manifold only after both the intake and the exhaust valves have been completely closed. Obviously the air will have to be throttled so that we can keep the air to fuel ratio as close to stoichiometry as possible.

The present invention teaches how to control the four events so that they occur at the appropriate times. Prior art 4 stroke engines always worked with camshafts, where the camshaft must rotate at half of the RPM's (revolutions per minute) of the crankshaft. Therefore the gear that connected the camshafts' rotations to the crankshaft's always had twice the number of teeth than the number of teeth on the corresponding gear of the crankshaft.

If we were to keep to this ratio in the current 2-stroke engine of the present invention, the lobes on the camshaft would be of too short a duration, coupled with too little lift to perform their function.

Therefore, the key to taking advantage of the two stroke concept to get more power with less displacement is to have the number and size of teeth of the camshafts' gear(s) be the same as the size and number of teeth on the crankshaft gear. This allows the camshaft(s) to rotate at the same RPM's as the crankshaft, and consequentially allows the lobes on the camshaft to have sufficient duration and lift to perform their function properly.

As taught hereinabove, the engines of the present invention comprise either a turbo charger or another method of compressing air to begin to push the air into the combustion chamber via the intake manifold in the latter part of the exhaust event and to continue to push air into the combustion chamber until the intake process is complete, between a quarter of the way up and half-way up the up stroke. The intake of air event ends and the compression event begins as soon as the intake valves or intake ports are fully closed.

The exhaust lobes on the camshaft(s) will have an approximate duration of 90 degrees of duration at 0.010 inches of lift. If intake valves are used, the intake lobes will have approximately between 90 and 135 degrees of duration at 0.010 inches of lift. If two intake valves are to be timed so that one is used for expelling the exhaust gasses and the second is used to supply air for combustion, then the duration of the one that is to be used for expelling the exhaust gasses could be in the 45 degree range.

When installing the camshaft(s) it is important that the exhaust valves begin to open (0.010 inches) at approximately half way down the power-exhaust stroke. Since their duration is 90 camshaft degrees the exhaust valves will be closed at bottom dead center.

The intake port or the intake valves must begin to open at approximately 45 degrees before BDC (Bottom Dead Center) and will close approximately a quarter of the way to halfway up the upward (intake-compression) stroke so that the upper half of the stroke can be the compression event.

There is thus provided according to another embodiment of the present invention, a system for providing improved fuel efficiency in a vehicle, the system including of a turbo charger with an electric motor attached to the shaft of the turbines that receives electricity whenever the starting motor receives electricity so that there will be sufficient air to start the engine.

Typically, a computer must be used to control fuel injection timing and quantity, and spark timing.

An existing engine that would benefit enormously from this teaching is Ford's 1 liter 3 cylinder eco-boost engine. This engine's sales are far from reaching its potential because it is underpowered for the American driver and because the engine runs very roughly since there is only one power event every 240 degrees of crankshaft rotation. This teaching would increase its power to that of a 2 liter 4 cylinder engine and it would run smoother than a 4 cylinder 4 stroke (or even a 4 cylinder 2 stroke) engine because there would be a power event every 120 degrees of crankshaft rotation.

There is thus provided according to an additional embodiment of the present invention A computer storage medium having instructions encoded therein for providing improved fuel efficiency in a vehicle two-stroke engine, wherein the camshaft(s) is (are) configured to rotate at the same rotational speed as the crankshaft;
a code for controlling the timing and the quantity of gasoline introduced directly into combustion chambers; and
b code for controlling spark timing; and
c code for controlling the throttling of the air to be used for combustion; and
d code for introducing fuel directly into the combustion chamber during the beginning of the compression event via a fuel injector, the fuel injector in fluid communication with a fuel tank and the combustion chamber above the piston in the piston shaft.

### SUMMARY OF THE INVENTION

It is an object of some aspects of the present invention to provide methods and apparatus for improving power and fuel efficiency in a gasoline vehicle.

The present invention provides a system and method for providing a wheel fuel efficiency of at least 30% in a gasoline internal combustion engine, the system including a two-stroke engine, a crank case and oil pump in fluid communication with said two-stroke engine but independent of the fuel system of the engine and at least one of a turbocharger and/or another means of providing compressed air in fluid communication with a combustion chamber in said two-stroke engine, wherein camshafts are allowed to rotate at the same number of revolutions per minute as the crankshaft and that the gasoline can be injected directly into the combustion chamber only after the intake valve has been closed and not via an intake manifold.

in prior art the 2 stroke diesel engines, these remaining burnt gases are expelled in by opening the intake valve—or the intake port—at around 45 degrees before bottom dead center of the downward stroke and allowing compressed air from the turbocharger or equivalent air compressing mechanism to expel the remaining burnt gases.

the exhaust valve is closed at bottom dead center and the intake valve—or intake port—remains open so that the combustion chamber can receive the air necessary for the next event—the intake of air event—to take place.

the intake valve would then be closed in the vicinity of between a quarter of the way up to around half-way up the upward (intake-compression) stroke so that the compression event can take place. if an intake port were to be used the intake port would be closed by the upward movement of the piston at the same position above bottom dead center that it was opened by the downward movement of the piston, approximately 45 degrees after bottom dead center.

one objective of this invention is to teach how to apply the benefits of a two stroke engine to an engine that burns gasoline from our knowledge of how a 2 stroke diesel engine profits from being 2 stroke rather than 4 stroke, which is the standard.

immediately after the intake valve has been totally closed, during the beginning of the compression event, and obviously after the exhaust valve has been closed, we will want to inject the gasoline directly into the combustion chamber without the gasoline passing through an intake manifold. in the diesel equivalent, the diesel fuel would only be injected towards the end of the compression event so that the temperature of the compressed air can ignite the fuel. in the gasoline version we want to inject the gasoline during the beginning of the compression event—but obviously only after both the intake and the exhaust valve(s) have been closed.

The obvious question is: since a diesel engine delivers 30% more miles per gallon than its gasoline equivalent, what are the advantages of building a gasoline equivalent?

there are two advantages to the gasoline version. the first advantage is that with a gasoline version we can employ a catalytic converter which will neutralize the combustion pollutants before they are emitted to the atmosphere.

the second advantage is that with a gasoline 2 stroke engine you do not begin the compression event until the piston is further up its upward stroke than in a 4 cylinder engine which allows the volume of the combustion chamber at top dead center to be very close to the volume of its diesel equivalent which will bring the gasoline miles per gallon to be approximately equal to the higher diesel miles per gallon because PV=NRT (Pressure×Volume=Quantity of Fuel×Temperature). This law of gasses teaches us that the smaller the combustion chamber is at top dead center the less fuel will be needed to drive the same distance.

The present invention provides a system and method for providing a wheel fuel efficiency improvement of at least 30% in a gasoline vehicle by combining the following attributes. The system includes a two-stroke gasoline engine which will have a crank case and oil pump in fluid communication with said two-stroke engine which is totally independent of the fuel, and at least one of a turbocharger and/or some method of compressing air in fluid communication with a combustion chamber and direct injection of the gasoline into the combustion chambers without passing through an the intake manifold in said two-stroke engine.

There is thus provided according to an embodiment of the present invention, a system for providing improved fuel efficiency in a vehicle, the system including;
a) a two-stroke engine that burns gasoline;
b) a crank case and oil pump in fluid communication with the two-stroke engine which operate independently of the fuel;
c) at least one of a turbocharger and/or some method of compressing air in fluid communication with a combustion chamber in the two-stroke engine;
d) a computer to control the timing and the quantity of injecting the gasoline directly into the combustion chambers and to control spark timing; and
e) one—or more than one—camshaft(s) that rotate at the same rotational speed as the crankshaft.

Additionally, according to an embodiment of the present invention, the two-stroke engine is constructed to perform four events, intake, compression, power and exhaust, which is the same as a 4 stroke engine except that the events in a 2 stroke engine occur over less crankshaft duration than in a 4 stroke engine. The intake event will have a duration of approximately between 90 and 135 crankshaft degrees while the other three events will each have a duration of approximately 90 crankshaft degrees. If there are intake ports rather than intake valves the duration of the intake event will also be approximately 90 crankshaft degrees.

Moreover, according to an embodiment of the present invention, the four events include;

a. an intake of the air event,

b. a compression event,

c. a power or expansion event, and

d. an exhaust event.

Furthermore, according to an embodiment of the present invention, the two-stroke engine further includes;
i. an air inlet valve in fluid communication with an air inlet conduit and the combustion chamber above the piston in the piston shaft, wherein the air inlet valve—or inlet port—is adapted to open in the intake event to expel the remnant of exhaust gasses and to enable a throttled quantity of air to remain in the combustion chamber for combustion purposes;
ii. a fuel injector in fluid communication with a fuel tank and the combustion chamber above the piston in the piston shaft, for introducing fuel into the chamber during the beginning of the compression event; and
iii. an exhaust valve, in fluid connection with an exhaust pipe, the exhaust valve adapted to enable combustion products of the air and fuel to exit the chamber in the exhaust event.

Further, according to an embodiment of the present invention, the oil pump is adapted to deliver lubricating oil to the walls of the combustion chamber during all of the strokes of the piston and to the other moving parts of the engine such as but not limited to the crankshaft and camshafts. The lubricating system operates independently of the fuel system.

Yet further, according to an embodiment of the present invention, at least one of a turbocharger and/or some other method of providing compressed air to provide the air to expel the remnant of exhaust gasses and to provide compressed air during the intake event in a predetermined volumetric ratio as close to stoichiometric as possible to a volume of the fuel.

Additionally, according to an embodiment of the present invention, the system further includes;
i. one, or more than one, camshaft and camshaft sprockets including teeth; and
ii. a crankshaft and a crankshaft sprocket including teeth;
wherein the camshaft sprockets and the crankshaft sprockets include an identical number of teeth and an identical size of teeth.

Furthermore, according to an embodiment of the present invention, the camshafts and the crankshaft are configured to rotate at identical speeds.

There is thus provided according to another embodiment of the present invention, a method for providing improved fuel efficiency in a vehicle, the method including;

a) providing a system as described herein; and

performing four events in the two-stroke engine, each event including a movement of a piston approximately equal to half a length of a piston' s stroke (that is approximately 90 degrees of duration) in the engine except that if there are intake valves the duration of the intake event could be as much as approximately 135 degrees, approximately 45 degrees in the downward stroke and approximately 90 degrees in the upward stroke.

Additionally, according to an embodiment of the present invention the four events include;
a) an intake event,
b) a compression event,
c) a power or expansion event, and
d) an exhaust event.

Moreover, according to an embodiment of the present invention, the method further includes;
i. opening an air inlet valve in fluid communication with an air inlet conduit and the combustion chamber above the piston in the piston shaft, during the intake event to enable a predetermined quantity of air to enter the chamber;
ii. introducing fuel into the combustion chamber after the intake and exhaust valves have been fully closed during the compression event via a fuel injector, the fuel injector in fluid communication with a fuel tank and the combustion chamber above the piston in the piston shaft; and
iii. enabling combustion products of the fuel to exit the combustion chamber in the exhaust event via an exhaust valve, in fluid connection with an exhaust.

Additionally, according to an embodiment of the present invention, the method further includes delivering lubricating oil to the walls of the combustion chambers and to the other moving parts of the engine such as but not limited to the camshaft(s) and crankshaft during the operation of the engine.

Moreover, according to an embodiment of the present invention, the method further includes providing the air in the combustion chamber for combustion purposes in a predetermined volumetric ratio as close to stoichiometric as possible to a volume of the fuel.

Further, according to an embodiment of the present invention, the method further includes mechanically connecting;
i. one or more camshafts and camshaft sprockets including teeth; and
ii. a crankshaft and a crankshaft sprockets including teeth;

wherein the camshaft sprockets and the crankshaft sprockets include an identical number of teeth of identical size.

Additionally, according to an embodiment of the present invention, the camshaft(s) and the crankshaft rotate at identical speeds.

Importantly, according to an embodiment of the present invention, the method provides a fuel efficiency to wheels of the vehicle a minimum of 30%.

Furthermore, according to an embodiment of the present invention, the fuel is gasoline.

The present invention will be more fully understood from the following detailed description of the preferred embodiments thereof, taken together with the drawings.

1. A system for providing improved fuel efficiency in an internal combustion engine, the system comprising:
a. a two-stroke engine that burns gasoline;
b. a crank case with engine lubricating oil and oil pump in fluid communication with said two-stroke engine that operates independently of the fuel;
c. at least one of a turbocharger, supercharger and/or another means of providing compressed air in fluid communication with a combustion chamber in said two-stroke engine;
d. direct injection of the gasoline into the combustion chambers; and
e. all camshafts must rotate at the same rotational speed as the crankshaft.

2. A system according to claim 1, wherein said two-stroke engine is constructed to perform four events to be controlled by one—or more than one—camshafts, each event comprising a movement of a piston of approximately equal to half a length of a piston's stroke in said engine except that if there are intake valves, they may have a duration as small as approximately 45 degrees and as large as approximately 135 degrees.

3. A system according to claim 2, wherein said four events comprise:
a. an intake event,
b. a compression event,
c. a power or expansion event,
d. an exhaust event, and

4. A system according to claim 3, wherein said two-stroke engine further comprises:
f. one or more air inlet valves in fluid communication with an air inlet conduit and said combustion chamber above said piston in said piston shaft, wherein said air inlet valve is adapted to open in said intake event to enable expelling of the exhaust gasses and to deliver a throttled quantity of compressed air to enter said chamber;
g. a fuel injector in fluid communication with a fuel tank and said combustion chamber above said piston in said piston shaft, for introducing fuel into said combustion chamber during the beginning of the compression event; and
h. one or more exhaust valves, in fluid connection with an exhaust pipe, said exhaust valve adapted to enable combustion products of said fuel to exit said chamber in said exhaust event.

5. A system according to claim 1, wherein said oil pump is adapted to deliver lubricating oil to all parts of the engine that require lubrication including but not limited to the walls of the combustion chambers, the crankshaft and the camshafts.

6. A system according to claim 1, wherein at least one of a turbocharger, supercharger and/or other means of providing compressed air are configured to provide said compressed air prior to and during said intake event in a throttled volumetric ratio to a volume of said fuel.

7. A system according to claim 2, wherein said system further comprises:
a. one or more than one camshaft and each camshaft has sprocket comprising teeth; and
b. a crankshaft and a crankshaft sprocket comprising teeth;
wherein said camshaft sprocket and said crankshaft sprocket comprise an identical number and size of teeth in order for the crankshaft and camshafts to rotate at identical rotational speeds.

8. A method for providing improved fuel efficiency in a vehicle, the method comprising:
a. providing a system according to claim 3; and
b. performing four events in said two-stroke engine, each event comprising a movement of a piston of approximately half a length of a piston stroke in said engine.

9. A method according to claim 8, further comprising:
a. opening an air inlet valve in fluid communication with an air inlet conduit and said combustion chamber above said piston in said piston shaft, during said exhaust purging and intake event to enable a predetermined quantity of air to enter said chamber;
b. introducing fuel directly into said combustion chamber without passing through an intake manifold during the beginning of the compression event via a fuel injector, said fuel injector in fluid communication with a fuel tank and said combustion chamber above said piston in said piston shaft;
c. enabling combustion products of said fuel to exit said combustion chamber in said exhaust event via an exhaust valve, in fluid connection with an exhaust.

10. A method according to claim 9, further comprising providing said compressed air prior to the intake event to assist in expelling the exhaust gasses and during said intake event to provide compressed air in a predetermined volumetric ratio to a volume of said fuel.

11. A method according to claim 10, wherein said camshaft and/or camshafts and said crankshaft rotate at identical speeds.

12. A method according to claim 8, wherein said method provides a fuel efficiency to wheels of said vehicle of approximately 30% or more.

13. A method according to claim 8, wherein said fuel is gasoline.

14. A method according to claim 8, wherein said vehicle is selected from the group consisting of a car, a motorbike, a bus, a lorry, a truck, a semi-trailer, an emergency vehicle, and an army vehicle.

15. A system for providing improved fuel efficiency in a vehicle, the system comprising of a turbo charger with an electric motor attached to the shaft of the turbines that receives electricity whenever the starting motor receives electricity so that there will be sufficient air to start the engine.
